(19) United States
(12) Patent Application Publication
(10) Pub. No.: US 2023/0198956 A1
(43) Pub. Date: Jun. 22, 2023

(54) DATA TRANSMISSION METHOD AND APPARATUS

(71) Applicant: BEIJING TUSEN ZHITU TECHNOLOGY CO., LTD., BEIJING (CN)

(72) Inventor: Qingyu SUI, Beijing (CN)

(21) Appl. No.: 18/069,981

(22) Filed: Dec. 21, 2022

Related U.S. Application Data
(60) Provisional application No. 63/293,032, filed on Dec. 22, 2021.

(51) Int. Cl. H04L 9/40

(52) U.S. Cl. CPC H04L 63/0407

(57) ABSTRACT

A data transmission method is provided to comprise determining data screening information, wherein the data screening information includes at least one data item to be transmitted back; acquiring target data corresponding to each of the data items from vehicle-end data corresponding to a vehicle; and sending the target data to a data receiver. Some embodiment of the disclosed technology allow to save the bandwidth of data transmission and reduce the delay of data transmission. Thus, the data receiver can obtain the data of interest quickly, be informed of the vehicle traveling state timely, and control the vehicle traveling more quickly.

### CROSS-REFERENCE TO RELATED APPLICATIONS

This application claims priority to and the benefit of U.S. Provisional Application No. 63/293,032, entitled, “DATA TRANSMISSION METHOD AND APPARATUS,” filed Dec. 22, 2021. The entire content of the before-mentioned patent application is incorporated by reference as part of the disclosure of this application.

### TECHNICAL FIELD

Various implementations of the disclosed technology relate to an automatic driving technology, and in particular to a data transmission method and a data transmission apparatus.

### BACKGROUND

With the development of automobile technology, a large amount of data can be collected by a vehicle during its traveling. For example, the collected data can include data collected by various sensors provided on the vehicle, such as data from the surrounding environment where the vehicle is traveling. The data collected by the vehicle can be stored, managed or analyzed for better vehicle controlling. In the related art, all data collected by a vehicle is transmitted to a data receiver.

### SUMMARY

Some embodiments of the present disclosure provide a data transmission method and a data transmission apparatus.

In a first aspect, the embodiment of the present disclosure provides a data transmission method, comprising: determining data screening information, wherein the data screening information includes at least one data item to be transmitted back; acquiring target data corresponding to each of the data items from vehicle-end data corresponding to a vehicle; and sending the target data to a data receiver.

In some examples, the data items in the data screening information include: data attributes of the target data corresponding to the data items, wherein the data attributes include at least one of a data generation object, data generation time, or a data type.

In some examples, the determining data screening information comprises: receiving the input data screening information.

In some examples, the determining data screening information comprises: generating the data screening information based on at least part of the vehicle-end data; wherein the at least part of the vehicle-end data includes at least one of: vehicle state data of the vehicle, environment data of the vehicle, or communication condition data of the vehicle.

In some examples, the determining data screening information comprises: acquiring at least part of the vehicle-end data corresponding to the vehicle; and determining the data screening information corresponding to the at least part of the vehicle-end data based on a preset mapping relationship between the vehicle-end data and the data screening information.

In some examples, the determining data screening information comprises: acquiring at least part of the vehicle-end data corresponding to the vehicle; and obtaining the data screening information output by a pre-trained screening model based on the at least part of the vehicle-end data input into the screening model.

In some examples, the determining data screening information comprises: obtaining first data screening information according to a first information generation mode; obtaining second data screening information according to a second information generation mode; and obtaining the final data screening information based on a joint processing of the first data screening information and the second data screening information.

In some examples, the first data screening information and the second data screening information include: an importance parameters corresponding to each of at least one data item to be transmitted back; the obtaining the final data screening information based on a joint processing of the first data screening information and the second data screening information comprises: selecting at least part of data items in the first data screening information and the second data screening information according to the importance parameters, and setting the at least part of data items in the final data screening information.

In some examples, the obtaining second data screening information according to a second information generation mode comprises: obtaining the second data screening information according to the second information generation mode based on at least part of the first data screening information.

In some examples, the determining data screening information comprises: obtaining multiple pieces of reference screening information, wherein each piece of the reference screening information includes at least one reference data item to be transmitted back; and determining the final data items included in the data screening information based on the reference data items included in the multiple pieces of reference screening information.

In some examples, the data screening information further includes: priority corresponding to each of the at least one data item; the sending the target data to a data receiver comprises: preferentially transmitting the target data corresponding to the data item with higher priority back according to the priorities of the data items.

In some examples, the determining data screening information comprises: determining the data screening information in response to module state data of a vehicle-end operation module in the vehicle indicating that the vehicle-end operation module is faulty; and the acquiring target data corresponding to each of the data items from vehicle-end data collected by a vehicle comprises: acquiring the target data corresponding to the faulty vehicle-end operation module in the vehicle corresponding to the data items from the vehicle-end data collected by the vehicle based on the data screening information.

In some examples, the determining data screening information comprises: determining the data screening information in response to the communication condition data for sending the target data to the data receiver being lower than the preset communication condition.

In some examples, the method is executed by a cloud server, and the data receiver comprises a plurality of front ends; the sending the target data to the data receiver comprises: sending the target data corresponding to the data items in the data screening information to corresponding front ends by the cloud based on the data screening information corresponding to each of the plurality of front ends.

In a second aspect, the embodiment of the present disclosure provides a data transmission apparatus, comprising: an information determination module configured for determining data screening information, wherein the data screening information includes: at least one data item to be transmitted back; a data acquisition module configured for acquiring target data corresponding to each of the data items from vehicle-end data corresponding to a vehicle; and a data sending module configured for sending the target data to a data receiver.

In a third aspect, the embodiment of the present disclosure provides an electronic device comprising a memory and a processor, wherein the memory is configured for storing computer instructions executable on the processor, and the processor is configured for implementing the data transmission method according to any one of the embodiments of the present disclosure when executing the computer instructions.

In a fourth aspect, the embodiment of the present disclosure provides a computer-readable storage medium having a computer program stored thereon, wherein the program, when executed by a processor, implements the method according to any one of the embodiments of the present disclosure.

In the data transmission method and the data transmission apparatus according to the embodiments of the present disclosure, by selecting the target data according to the data screening information, the data is transmitted back on demand, which saves the bandwidth of data transmission and reduces the delay of data transmission, so that the data receiver can obtain the data of interest quickly, know about the vehicle traveling state timely and control the vehicle traveling more quickly.

### BRIEF DESCRIPTION OF THE DRAWINGS

In order to more clearly illustrate one or more embodiments of the present disclosure or technical schemes in related arts, the drawings used in the embodiments or descriptions in related arts will be briefly described below. It is obvious that the drawings in the description below are only some embodiments described in one or more embodiments of the present disclosure, and other drawings can be derived from these drawings by those of ordinary skilled in the art without making creative efforts.

FIG. 1 is a schematic diagram showing the architecture of a data transmission system according to at least one embodiment of the present disclosure;

FIG. 2 is a schematic flowchart showing a data transmission method according to at least one embodiment of the present disclosure;

FIG. 3 is a schematic flowchart showing a data transmission method according to at least one embodiment of the present disclosure;

FIG. 4 is a schematic flowchart showing a data transmission method according to at least one embodiment of the present disclosure; and

FIG. 5 is a schematic diagram showing the structure of a data transmission apparatus according to at least one embodiment of the present disclosure.

### DETAILED DESCRIPTION

Example of various technical schemes in one or more embodiments of the present disclosure will be described below with reference to the drawings in one or more embodiments of the present disclosure. It is obvious that the described embodiments are examples only and other embodiments can be still made based on one or more embodiments of the present disclosure within the scopes of the present disclosure.

FIG. 1 is a schematic diagram showing the architecture of a data transmission system according to at least one embodiment of the present disclosure. As shown in FIG. 1, vehicles can transmit the collected vehicle-end data to a cloud server 14. For example, a vehicle 11, a vehicle 12, and a vehicle 13 are illustrated in FIG. 1. The cloud server 14 forwards the vehicle-end data to a front end 15. The front end 15 may be a client installed on devices such as a computer or a mobile terminal of an administrator. The administrator can learn the traveling situation of the vehicle end according to the vehicle-end data received by the front end 15.

In one example, the vehicle in the data transmission system may be an autonomous vehicle. The autonomous vehicle may be a vehicle that senses the surrounding environment of the vehicle through various sensors and obtains the vehicle position, road information, obstacle information, and others. The autonomous vehicle operates based on various sensing results, thereby automatically controlling the vehicle traveling to some extent. In other examples, the vehicle in the data transmission system may be a common vehicle, not an autonomous vehicle. When the vehicle is an autonomous vehicle, the vehicle-end data collected by the vehicle may be real-time and/or non-real-time vehicle-end data collected by the autonomous vehicle. For example, the non-real-time data can include driver information on the vehicle, tester information, vehicle number, map information for vehicle usage, and the like. The real-time data can include road information, vehicle position and other dynamic information collected by sensors during the vehicle traveling.

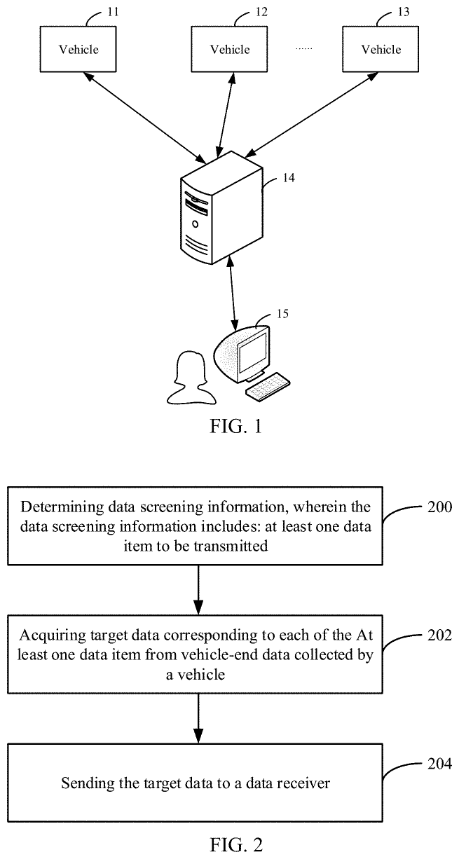

FIG. 2 is a flowchart showing a data transmission method according to some embodiments of the present disclosure. For example, the method can be executed by the vehicles in the system shown in FIG. 1 or the cloud server in the system shown in FIG. 1, or can be implemented by the interaction between the vehicles and the cloud server. As shown in FIG. 2, the method can comprise following operations:

step 200: determining data screening information, wherein the data screening information includes: at least one data item to be transmitted back;

step 202: acquiring target data corresponding to each of the data items from vehicle-end data collected by a vehicle;

step 204: sending the target data to a data receiver.

The processes of steps 200 to 204 will be explained in detail in the below.

First, the following concepts involved in the above processes are explained.

1) Data screening information: In this embodiment, the data screening information may be information used as a basis for screening required data from the vehicle-end data collected by the vehicle. For the data receiver, if not all of the vehicle-end data collected by the vehicle is needed, but part of the vehicle-end data is of interest, only the part of the vehicle-end data of interest can be transmitted to the data receiver. The data screening information can be used to define the vehicle-end data needed by the data receiver.

2) Data item: Data items may refer to each type of data screening information, or may be a part of information included in the data screening information, and other information in addition to the data items, for example, the priority mentioned in the following embodiments, can be included in the data screening information. When the data screening information defines or configures the vehicle-end data needed by the data receiver, a variety of vehicle-end data needs to be transmitted back, and each of the vehicle-end data can be referred to as a data item.

By way of an example, if the data screening information defines that data generated by an algorithm module C1 and data collected by a sensor C2 of the vehicle end need to be transmitted back, the data generated by the algorithm module C1 can be referred to as one data item, and the data collected by the sensor C2 can be referred to as another data item.

It should be noted that the above example is merely illustrative, and the embodiments of the present disclosure do not limit the ways to divide data items, and the data items can be independently defined according to various requirements, for example, business related requirements.

In some examples, the data screening information, when defining at least one data item to be transmitted back, can define or configure the content of the data item. For example, the data screening information can define data attributes of the target data corresponding to the data items, wherein the data attributes include at least one of a data generation object, data generation time and a data type.

For example, the data generation object can refer to a source of the data or a corresponding object of the data, for example, data of an object or data generated by an object, for example, data collected by a camera and Lidar in the vehicle, data output by a lane line detection module in the vehicle, or performance data corresponding to an automatic driving system in the vehicle.

In another example, the data generation time refers to time required to acquire data. For example, the vehicle-end data is generated over a particular time period. For example, the data collected by the Lidar sensor of the vehicle is acquired over a period from 15:00 to 18:00.

For yet another example, the data type can include, but is not limited to, performance data such as CPU usage, memory usage and network packet loss rate; availability data such as frame rate data and delay data; or data such as vehicle position data and data collection accuracy of the vehicle end.

3) Vehicle-end data: in this embodiment, the vehicle-end data can be considered as data generated on the vehicle side.

In one example, the vehicle-end data can include at least one of the following: vehicle state data collected by sensors mounted on the vehicle, environment data of the surrounding environment where the vehicle is traveling, or communication condition data of the vehicle and post-processing data based on these data.

The sensors can include an inertial measurement unit (IMU), a global positioning system (GPS) transceiver, a radar (RADAR) unit, a laser range/LIDAR unit (or other distance measurement apparatus), an acoustic sensor, and/or image acquisition apparatus such as a camera.

The vehicle state data can include a vehicle pose state. Pose may refer to position and orientation. For example, the vehicle pose state can include 6 degrees of freedom, including 3 degrees of freedom for position and 3 degrees of freedom for orientation. The 3 degrees of freedom for orientation are usually indicated by pitch, roll and yaw. The vehicle state data can also include performance data of a node (e.g., a node may be a certain algorithm module operating in the vehicle) or a system in the vehicle. For example, the performance data may be CPU usage or memory usage of the automatic driving system, or may be the transmission data between nodes in the vehicle or operation delay data of the nodes, and the like.

The environment data, for example, can include, but is not limited to, an environment image of the environment where the vehicle is located, point cloud data of the environment, pose data of surrounding vehicles and the like.

The communication condition data of the vehicle may be data of the vehicle end that is capable of indicating network communication conditions. For example, the communication condition data may be or include a data transmission rate. In the following description of the embodiment, the data screening information can also be determined according to the communication condition data, For example, under good network communication conditions, the vehicle can transmit a larger amount of or even all of the vehicle-end data to the data receiver. Assuming that the network connection state between the vehicle and the data receiver in a certain time period is poor, and the data transmission rate therebetween is lower than the set transmission rate value, the data screening information can be determined to perform data screening accordingly, and only the screened target data is transmitted to the data receiver. By doing so, it is possible to reduce the network load, improve the transmission efficiency, and ensure that the data receiver receives the data of interest as soon as possible.

4) Target data: the target data may be data screened from the vehicle-end data according to the data screening information. For example, there may be much vehicle-end data collected on the vehicle side, and the data screening information defines that only two data items of “data generated by the algorithm module C1” and “data collected by the sensor C2” need to be transmitted back, so that the vehicle-end data of the two data items can be referred to as target data.

On the basis of the description of the above concepts involved in the processes, the steps in FIG. 2 are explained.

In step 200, the data screening information can be determined in various modes.

In one example, the execution subject of the data transmission method according to this embodiment can receive the input data screening information. It should be noted that this embodiment does not limit the execution subject of the method, and the method can be executed by the vehicle or the cloud server.

When the method is executed by the cloud server, the research personnel can configure the data screening information on their computers and upload the configured data screening information to the cloud server. Then, from the perspective of the cloud server, the cloud server only needs to receive the data screening information. For example, a front-end human-computer interaction interface for the research personnel to set the data screening information can be provided. The research personnel can set the vehicle-end data of interest (for example, data collected by Lidar at the vehicle end) in the data screening information through the human-computer interaction interface according to their requirements, and send the set data screening information to the cloud server.

When the method is executed by the vehicle, the cloud server can forward the received data screening information configured by the research personnel to the vehicle side. Then, from the perspective of the vehicle, the vehicle directly receives the data screening information, and subsequently, the vehicle can execute data screening according to the data screening information.

In another example, the data screening information of this embodiment may be the generated information instead of the directly received input information. The data screening information can be determined based on at least part of the vehicle-end data on the vehicle side, wherein the vehicle-end data includes at least one of vehicle state data, environment data and communication condition data.

In the mode of generating the data screening information based on the vehicle-end data, the vehicle-end data such as the vehicle state data and the environment data can reflect the operation state or the operation environment that the vehicle end is in. Base on such vehicle-end data, the data screening information is determined, so that the data items to be transmitted back can be dynamically adjusted and determined based on the condition of the vehicle side, and automatic dynamic adjustment of the data transmitted back is realized. Different vehicle-end conditions can correspond to different data items to be transmitted back, which improves the efficiency and accuracy of data back-transmission to some extent and helps the data receiver to receive data of interest more quickly.

In addition, the determining the data screening information can have a condition for triggering screening, or can be executed at any time, which is not limited in the embodiments of the present disclosure. Examples are as follows.

For example, after the research personnel have configured the data screening information and uploaded the data screening information to the cloud server, the cloud server can report the screened information to the cloud after instructing the vehicle end to perform the data screening according to the data screening information all the time. That is, the cloud server can report the target data according to the data screening information in a fixed and normalized manner.

For another example, a trigger condition can be specified for executing data screening, and it can include multiple types, including but not limited to, a time condition, a data condition, a communication condition, and the like. In an example of the time condition, the research personnel can specify a time period from 15:00 to 20:00 to perform data screening when uploading the data screening information to the cloud server. In an example of the data condition, the vehicle end can send only the collection frame rate of each of the vehicle-end data according to a predetermined period in the case of normal data transmission, while sending corresponding target data according to the determined data screening information in response to that the collection frame rate of the vehicle end is abnormal. In an example of the communication condition, in response to that the communication condition data of the sending of the target data to the data receiver by the execution subject of the data transmission method according to the embodiments of the present disclosure is lower than the preset communication condition, for example, the data cannot be transmitted by network, the action of determining the data screening information can be executed, and part of the target data can be acquired for back transmission based on the determined data screening information.

For yet another example, in a case where the cloud server corresponds to a plurality of vehicles, as shown in FIG. 1, a particular portion of the vehicles can also be specified to execute data screening. For example, a fleet of autonomous vehicles traveling in the same road environment may have the same fault due to external environmental factors, and at this time, one or more vehicles in the fleet may be specified to transmit particular data items back. In one example, the research personnel can configure the data screening according to the embodiments of the present disclosure to be executed by the vehicle 12 rather than the vehicle 11 and the vehicle 13 of FIG. 1. Thus, the cloud server 14 can merely instruct the vehicle 12 to execute the method.

In step 202, corresponding target data can be acquired according to the data screening information.

In one example, assuming that the data screening information defines that data of the lane line detection module and the Lidar sensor in the vehicle is to be acquired, data corresponding to a time period from 15:00 to 18:00 is to be acquired via the network, and the type of the data to be acquired is frame rate data output by the lane line detection module, then, according to the data screening information, the data collected by Lidar and the frame rate data of the lane line detection module in a time period from 15:00 to 18:00 can be obtained as target data.

In step 204, the target data obtained according to the data screening information can be sent to the data receiver. It should be noted that in terms of sending the target data to the data receiver in this embodiment, it can include a broad understanding, that is, it can be construed as sending the target data itself or a data processing result obtained after the analysis of the target data to the data receiver.

For example, the target data may be data collected by the Lidar sensor of the vehicle end, which can be directly transmitted to the front end as a data receiver by the cloud server, and analyzed locally by the data receiver. Alternatively, the target data can be analyzed by the cloud server, and then the data processing result is transmitted to the front end.

In one example, the target data can be analyzed in such a way that the changes in a certain data item over a history time period are shown in a form of a graph and updated in real time, where the horizontal axis of the graph may represent time, and the vertical axis may represent the history value of the data. Alternatively, the target data can be analyzed in such a way that the data is played back in real time, for example, the data receiver can read the data locally and perform the playback similar to the vehicle depot through the corresponding tool after receiving the target data. Alternatively, the target data can be analyzed in such a way that the target data is processed locally and automatically by the data receiver through a script to obtain the data processing results.

In addition, when the method according to this embodiment is executed by the cloud server, the data receiver may be the front end in the system shown in FIG. 1. The cloud server can obtain the target data from the vehicle-end data based on the data screening information, and sends the target data to the front end. There may be a plurality of front ends.

When there is a plurality of front ends, each front end can have its own corresponding data screening information. The cloud server can screen the target data based on their own corresponding data screening information, and sent the target data to the corresponding front end. For example, assuming that the plurality of front ends include a front end D1, a front end D2 and a front end D3, and taking data to be acquired by the front end D3 as an example, the front end D3 can be referred to as a target front end, and the cloud server can acquire corresponding target data from the vehicle-end data and transmit the corresponding target data back to the front end D3 based on data screening information corresponding to the front end D3.

In some embodiments, the data screening information to be finally used can be determined based on the data screening information set by each of the plurality of front ends. In this embodiment, the data screening information set by each of the plurality of front ends can be referred to as reference screening information, and the data item to be transmitted back included in each piece of the reference screening information can be referred to as a reference data item. The data items included in the final data screening information can be determined based on the reference data items included in the multiple pieces of reference screening information.

For example, the cloud server can sort the reference data items included in all the data screening information of the plurality of front ends according to the number of occurrences, and take the top n reference data items as the data items in the final data screening information. The top n may be all reference data items of the plurality of front ends or part of reference data items, which is not limited in the present disclosure. By way of an example, assuming that there are multiple pieces of reference screening information for 10 front ends, among which 8 pieces of reference screening information are configured with “data of algorithm module C1” as reference data items to be transmitted back, 5 pieces of reference screening information are configured with “data of sensor C2” as reference data items, and so on. Then, the number of occurrences of each reference data item is counted and the top n reference data items are used as the data items in the final data screening information. In another implementation, a threshold for the number of occurrences can be set, with the reference data items having more than 5 occurrences used as the data items in the final data screening information.

In addition, the threshold method and the sorting method are both examples, and other selection methods can also be adopted in practical implementation, which is not limited in this embodiment. In one example, for the purpose of determining the data items to be added to the final data screening information, the corresponding priority can also be set based on the usage of the data items in the multiple pieces of reference screening information. For example, for a certain data item, the corresponding priority can be set according to its occurrence ranking in the multiple pieces of reference screening information. The reference data item with a larger number of occurrences has a higher priority in the final data screening information, and the target data corresponding to this data item will be preferentially transmitted back at the vehicle end.

The multiple pieces of reference screening information may be real-time information or history storage information.

By way of an example, in a real-time processing mode, assuming that the plan to screen vehicle-end data is about to start, then, a plurality of front ends can upload their own reference screening information to the cloud server (or the plurality of front ends can be triggered to upload their respective reference screening information in response to that a condition for triggering the screening is met at the vehicle end), where the reference screening information may be configured on a human-computer interaction interface of the front end and uploaded to the cloud server by research personnel. The cloud server sets the data items with a larger number of occurrences in the final data screening information according to the above example based on the multiple pieces of reference screening information, and instructs the vehicle end to transmit back the target data corresponding to the data items in the data screening information. Certainly, the vehicle end can also upload more vehicle-end data, and the cloud server executes the screening processing according to the data screening information.

In another example history storage mode, the multiple pieces of reference screening information may be history reference screening information stored in the cloud server. For example, when a certain fault occurs at the vehicle end, some front ends are configured with one type of reference screening information, which can include some reference data items to be transmitted back, while the other front ends are configured with another type of reference screening information, and the like, and then the cloud server can store the multiple pieces of reference screening information that has been used by the front ends historically for the same fault. When the fault occurs again at the vehicle end, the cloud server can generate data items included in the final data screening information based on the multiple pieces of reference screening information stored historically.

Optionally, the cloud server can also display the data items generated according to the multiple pieces of reference screening information stored historically to the research personnel in a visual manner, which is equivalent to automatically recommending the data items to the research personnel, and the research personnel can further select the data items to be used this time from the data items, or add data items that they want to transmit back on this basis. This is equivalent to combining at least two modes of generating data screening information to obtain final data screening information, so that the mode of determining the data screening information is more flexible. For example, in the above example, one mode is to determine the data screening information based on multiple pieces of reference screening information, and the other mode is to receive manually input or selected data screening information.

In the data transmission method according to this embodiment, by selecting the target data according to the data screening information, the data is transmitted back on demand, which saves the bandwidth of data transmission and reduces the delay of data transmission, so that the data receiver can obtain the data of interest quickly, control the vehicle traveling more quickly, and know about the vehicle traveling state timely according to the received data.

Two more modes of determining data screening information are exemplified below.

In one example, the data screening information corresponding to at least part of the vehicle-end data of the vehicle end can be determined based on a preset mapping relationship between the vehicle-end data and the data screening information. This mode can also be referred to as a screening rule-based data screening information generation mode.

Optionally, the mapping relationship can be pre-configured by the research personnel to define a corresponding relationship between the vehicle-end data and the data screening information. The research personnel can upload the configured mapping relationship to the cloud server, and the cloud server determines the data items in the data screening information according to the mapping relation.

For example, one mapping relationship can be set as follows: in response to the execution rate (for example, the data transmission frame rate) of a certain algorithm module at the vehicle end is lower than a preset threshold value f1 with the duration reaching t1, the CPU and/or GPU usage corresponding to the algorithm module is obtained. Then, in the mapping relationship, the vehicle-end data can include the execution rate and the duration of the algorithm module, and the corresponding data screening information is the CPU and/or GPU usage of the algorithm module. The relationship between the vehicle-end data and the data screening information defined by the mapping relationship is related through a threshold value, and when the result of vehicle-end data is lower than the threshold value, the data screening information is obtained based on the mapping relationship.

In addition, the mapping relationship is only an example, and can be flexibly set in practical implementation. The vehicle-end data in the mapping relationship may be either original data collected by the vehicle end or data processing results after the analysis of the original data. For example, the vehicle-end data may be an execution rate of the algorithm module or a module state of the algorithm module obtained according to the execution rate. The module state is the analysis result obtained by the conversion of the execution rate. The module states corresponding to different value ranges of the execution rate of the algorithm module can be set according to the different value ranges; if the execution rate is lower than a certain value, the state of the algorithm module can be set to WARNING, and if the execution rate is further decreased, the WARNING state is changed to ERROR state. When the vehicle-end data is the above module state, one mapping relationship can be set to “if the module state of the algorithm module is WARNING, the CPU usage of the algorithm module is set as a data item to be transmitted back in the data screening information”, and the other mapping relationship can include “if the module state of the algorithm module is ERROR, the algorithm delay data is set as a data item to be transmitted back in the data screening information”.

In another example, at least part of the vehicle-end data corresponding to the vehicle can be acquired, and the data screening information output by a pre-trained screening model can be obtained based on the at least part of the vehicle-end data input into the screening model.

In this example, the data screening information is also generated based on at least part of the vehicle-end data, with the difference from the rule-based mode in that the mapping relationship can be manually set, for example, the content of the data screening information can be manually set when the vehicle-end data meets a certain condition. The screening model-based mode is to define the relationship between the vehicle-end data and the data screening information by the model.

For example, a screening model can be pre-trained with sample data in multiple scenarios, and the specific form of the screening model is not limited by this embodiment. The sample data in each scenario should include input data capable of identifying abnormal operation of the scenario and target screening data that needs to be mainly collected when the scenario is running abnormally, so that the model input of the screening model trained according to the sample data is the vehicle-end data capable of identifying whether the algorithm module is running abnormally, and the model output may be the data screening information when the abnormality occurs, which can define the data attributes of data items to be transmitted back, such as data generation time and data types.

Similarly, the pre-trained screening model can be deployed on a cloud server or a vehicle end, so that data screening information can be generated based on the screening model.

As described above, various modes such as manually configuring data screening information, determining data screening information based on rules and determining data screening information based on models are exemplified, and further, in the various modes of determining data screening information, the generated data screening information can also include priority corresponding to each of at least one data item to be transmitted back.

By way of an example, the plurality of data items to be transmitted back included in the data screening information can include “data generated by algorithm module C1” and “data generated by sensor C2”, and the priority of each data item can also be included in the data screening information, for example, the highest priority of the “data generated by algorithm module C1”, and the second highest priority of the “data generated by sensor C2”.

When the target data corresponding to the data item is sent to the data receiver, the target data corresponding to the data item with higher priority can be preferentially transmitted back according to the priority corresponding to each of the data items. For example, the “data generated by algorithm module C1” is preferentially transmitted back.

In this way, the data receiver can be guaranteed to receive the most important data more quickly. For example, when a fault occurs at the vehicle end, the data with the highest priority can be the data most relevant to the generated fault or the data most likely to cause the fault, so that the preferential transmission of these data can help to solve the problem faster; or when the network communication condition is poor, the preferential transmission of the data with the highest priority helps to acquire more important data faster.

In addition, in various modes of determining the data screening information in the above examples, the determined data screening information can include the priority corresponding to each of the data items. For example, the data screening information including the above priority can be automatically output by the screening model. For another example, not only data items to be transmitted back but also the priority of the data items can be set in the data screening information by the research personnel when configuring the mapping relationship.

In other examples, when setting the priority in the data screening information, the research personnel can directly configure the priority of each of the data items, or set a calculation method for the priority of the data items, so that when determining the data screening information, the execution subject generating the data screening information automatically calculates the priority of each of the data items according to the calculation method.

By way of an example, assuming that there is a plurality of algorithm modules at the vehicle end that are in the WARNING or ERROR state, and all of the algorithm modules have data items to be transmitted back, then, the data importance of the algorithm modules can be calculated, for example, it can be calculated according to a preset calculation method based on the extent to which the state value of the module exceeds a normal state threshold, the importance of the algorithm module itself or other factors; and the algorithm modules can be ordered according to the calculated data importance. The data item corresponding to the algorithm module with the highest importance has the highest priority. Taking the cloud server executing the generation of the data screening information as an example, the cloud server can collect parameters that affect t the data importance, calculate the data importance according to the collected parameters, and perform sorting according to the data importance to obtain the priority of the data items of each of the algorithm modules.

Further, as mentioned above, there may be various data generation modes for the data screening information, such as a screening rule-based mode and a screening model-based mode. In the practical processing, the final data screening information can be obtained according to a single mode or a combination of at least two modes.

In one example, first data screening information can be obtained according to a first information generation mode, second data screening information can be obtained according to a second information generation mode, and the final data screening information can be obtained based on a joint processing of the first data screening information and the second data screening information. The first information generation mode and the second information generation mode may be different generation modes. For example, the first information generation mode may be a screening rule-based mode, and the second information generation mode may be a screening model-based mode. The joint processing means that the final data screening information is obtained by referring to the first data screening information and the second data screening information.

In one example, the first data screening information and the second data screening information can include an importance parameter corresponding to each of at least one data item to be transmitted back. For example, the first data screening information includes two data items, one of which is “data of algorithm module C1” (tentatively referred to as a first data item), the other of which is “data of sensor C2” (tentatively referred to as a second data item), and the importance parameter corresponding to the first data item is 0.25 and the importance parameter corresponding to the second data item is 0.78, which can be used for indicating the correlation between the data item and the vehicle-end problem (assuming that the vehicle-end problem is that a fault occurs). The second data screening information includes four data items and their corresponding importance parameters, and the data items in the first data screening information and the second data screening information can be ordered according to the importance parameters. The top M relatively important data items are set in the final data screening information, where M is a natural number. The importance parameter can be the confidence level of each data screening information output by the model, or a score value calculated based on the number of occurrences of each data screening information set by the research personnel, or the degree of relevance between data screening information and real vehicle problems that is pre-stored in the mapping relationship. Optionally, all or part of the data items can be selected according to the importance parameter threshold. For example, any data item having higher importance than a certain threshold can be set in the data screening information. In other examples, the importance parameter may have other meanings, and here, by way of an example only, the importance parameter can be considered as a basis for selecting at least part of the data items from the first data screening information and the second data screening information.

In another example, the same data item is included in the first data screening information and the second data screening information, for example, the vehicle position data is included in both data screening information, but it is possible that the importance parameters of the vehicle position data in both data screening information are different. In this case, the importance parameters of the same data item in the first data screening information and the second data screening information can be combined (for example, two importance parameters of the vehicle position data are weighted average) to be used as the importance parameters of the data item, and different data items are ordered according to the importance parameters to select at least part of the data items.

In yet another example, the first information generation mode and the second information generation mode may be in a parallel relationship or a serial relationship. For example, after the first data screening information and the second data screening information are generated by the two information generation modes, part of the data items are selected according to the above example of the importance parameter. The second data screening information can be obtained by using at least part of the first data screening information as input into the second information generation mode. For example, the data screening information obtained based on screening rule is used as the input of the screening model; or the screening information obtained based on the model is used as the screening condition based on the screening rule mode.

By way of an example: firstly, two data items, namely vehicle position data that needs to be transmitted back and data of a perception algorithm, are determined in the screening rule-based mode. However, the data of the perception algorithm can include a lot of data, for example, 100 pieces of data, so that the data of the perception algorithm can be continued to be input as a model in the screening model-based mode, and 20 pieces of data selected from the 100 pieces of data can be output by the screening model. These 20 pieces of data are then set in the final data screening information together with the above vehicle position data.

It should be noted that in the above example, the first information generation mode and the second information generation mode are exemplified, but in the practical implementation, the generation mode is not limited to a combination of the two modes, and a combination of multiple generation modes can be included to obtain the final data screening information.

In this embodiment, taking the cloud server executing the data screening as an example, the cloud server may not collect data, or may collect data only at a low frequency by default. Only after receiving the data screening information and starting to execute the data screening, the cloud server collects the target vehicle-end data at a high frequency.

For example, the vehicle end can normally collect all data through its sensor, but may not report to the cloud server at the beginning, or may report at a low frequency, for example, it uploads 10 frames of images per second. After the research personnel upload the data screening information to the cloud server, the cloud server instructs the vehicle end to report the data corresponding to the data screening information, and then the vehicle end increases the reporting frequency, for example, it uploads 100 frames of images per second. In this way, network transmission resources can be saved, and data is transmitted only when needed.

In addition, the sending the target data to the data receiver can be construed as sending the original data or a data processing result obtained after the analysis of the original data to the front end by the cloud server. The analysis may be real-time analysis or off-line analysis.

For example, the research personnel can configure data screening information on their own computers in the hope of acquiring environmental data of objects around the vehicle and collecting accuracy data. The research personnel can upload the data screening information to the cloud server, which then instructs the vehicle end to report the above data. The vehicle end transmits corresponding data back to the cloud in real time at high frequency. After the cloud server sends the data to the front end of the research personnel, the data can be processed through a script of the front end and then visualized to enable better knowledge of the vehicle traveling condition. Moreover, whether data errors occur can be determined according to the collected accuracy data. For another example, the research personnel can also instruct the vehicle end to transmit the vehicle position back in real time in the same way, and quickly know the road section (highway, common road, and the like) where the vehicle is located and the position of the specific road section through the map that displays the vehicle position information in real time.

In the data transmission method according to this embodiment, by selecting the target data according to the data screening information, the data that really needs to be transmitted back is screened out and transmitted back on demand, which saves the bandwidth of data transmission and reduces the delay of data transmission, so that the data receiver can obtain the data of interest quickly, control the vehicle traveling more quickly and know about the vehicle traveling state timely according to the received data. Moreover, the data screening information of this embodiment can be dynamically generated. For example, the data screening information that varies with the input vehicle-end data can be determined according to the screening rule or screening model in such a dynamic way that the important data to be collected can be automatically changed along with different running conditions of the vehicle, so that the relatively important data can be transmitted to the receiver more quickly and accurately to help the receiver to solve the problem by using the data more quickly. In addition, in this embodiment, the priority of the target data transmitted back is also refined to better ensure that the data is transmitted back in time according to the importance.

The data transmission method according to the embodiments of the present disclosure can be applied to an automatic driving scenario. For example, in the system shown in FIG. 1, the vehicle may be an autonomous vehicle, and the scenario may be that the autonomous vehicle transmits the data to the front end during traveling.

It will have better advantages to execute the method according to any one of the embodiments of the present disclosure in the automatic driving scenario.

For example, when a certain component or algorithm module at the vehicle end has a fault during the autonomous vehicle traveling, the relevant fault data collected by the autonomous vehicle can be transmitted back to the front end of the research personnel as soon as possible by executing the data screening according to the embodiments of the present disclosure, so that the research personnel can locate and solve the problem as soon as possible according to the data transmitted back. Moreover, the autonomous vehicle does not need to transmit all collected data back in real time, but only needs to transmit the data of interest back to the research personnel according to their requirements, so that network transmission resources are saved, and the data transmission efficiency is improved.

In addition, from the perspective of a manager or research personnel, it is more convenient to control the autonomous vehicle. The required vehicle-end data can be easily controlled for back transmission in time by the method according to the embodiments of the present disclosure, thereby aiding in locating and solving the vehicle-end problem of the autonomous vehicle better and faster, performing analysis and debugging based on data, or knowing about the driving condition of the vehicle.

The following two scenarios for applying the data transmission method according to the embodiments of the present disclosure in autonomous driving are exemplified.

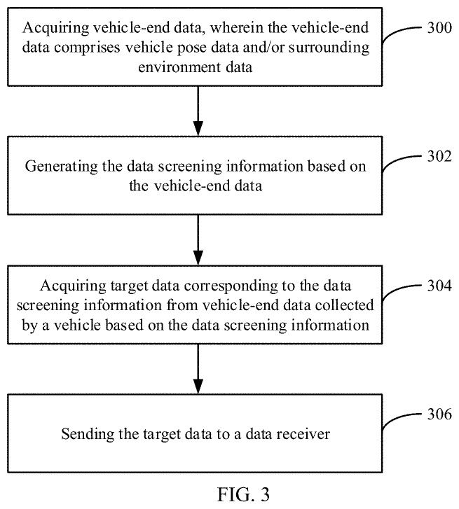

FIG. 3 is a flowchart showing a data transmission method according to at least one embodiment of the present disclosure. In this example, the target data to be screened can be automatically transformed according to vehicle information. As shown in FIG. 3, the method can comprise the following processes.

Step 300: acquiring vehicle-end data, wherein the vehicle-end data comprises vehicle pose data and/or environment data.

In this step, the vehicle pose data may be at least of the position data and attitude data of the vehicle, and the environment data may be data collected by a camera or other sensors on the vehicle, for example, a surrounding environment image captured by the camera during the vehicle traveling, a processing result obtained by processing the surrounding environment image, or information of a surrounding object sensed by the sensors on the vehicle.

The autonomous vehicle can always collect the above vehicle-end data during traveling. If data screening is executed at a cloud server, the vehicle can report the vehicle-end data to a cloud server. If data screening is executed at a vehicle end, the vehicle end can acquire the vehicle-end data by itself.

Step 302: generating the data screening information based on the vehicle-end data.

For example, the data screening information can be generated in this step based on a screening rule or a screening model. The specific mode can be referred to the above embodiments, which is not detailed here again. For example, in a screening rule-based mode, the corresponding different data screening information can be obtained for different vehicle pose data and/or environment data as vehicle-end data according to a preset mapping relationship.

In some examples, when the autonomous vehicle travels on a high-risk road section, for example, when it is determined that the autonomous vehicle travels on a road section with relatively high shielding, relatively dark environment, and relatively low GPS accuracy according to vehicle position data or a processing result of an image collected by a vehicle camera, vehicle-end data related to the operation of a safety officer (for example, including audio and video streams from a vehicle-end monitoring device, a human-computer interaction interface screen recording, and the like) and vehicle position data can be transmitted back as the target data. Further, the priority of the data to be transmitted back can be set such that the vehicle-end data related to the operation of the safety officer is transmitted back preferentially. The vehicle position data is set with the second priority.

Step 304: acquiring target data corresponding to the data screening information from vehicle-end data collected by a vehicle.

For example, in the above example, the vehicle-end data related to the operation of the safety aspects (for example, including audio and video streams from a vehicle-end monitoring device, a human-computer interaction interface screen recording, or others), vehicle position data, and/or others can be transmitted back.

Step 306: sending the target data to a data receiver.

For example, the vehicle sends the target data to a cloud server, the cloud server sends the data to the front end, and the administrator monitors the traveling of the autonomous vehicle in time according to the monitoring data transmitted back such as the audio and video streams.

According to the data transmission method according to this embodiment, the data screening information is determined according to the vehicle-end data of the vehicle, and the target data is transmitted back according to the data screening information, so that the autonomous vehicle can transmit the required monitoring data of the corresponding road section state on different road sections, for realizing the better safety monitoring of the autonomous vehicle.

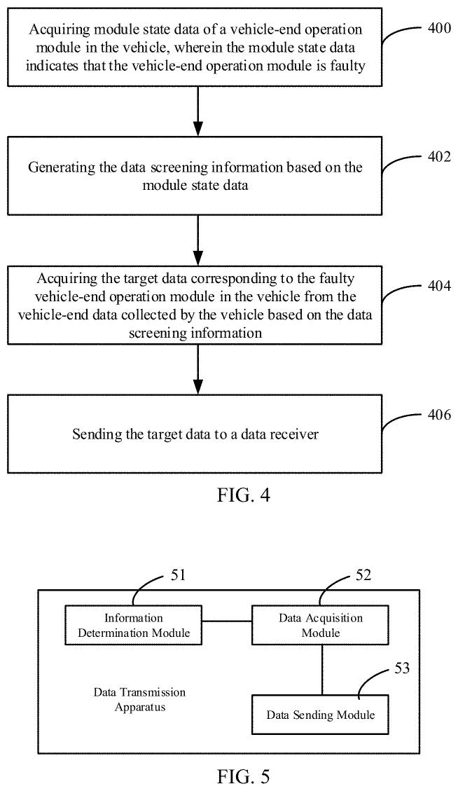

FIG. 4 is a flowchart showing another data transmission method according to some embodiments of the present disclosure. In this embodiment, when an autonomous vehicle is faulty, the data required for troubleshooting can be transmitted back as soon as possible by the method according to the embodiments of the present disclosure, thereby aiding in solving the problem as soon as possible. As shown in FIG. 4, the method can comprise the following processes.

Step 400: acquiring module state data of a vehicle-end operation module in the vehicle, wherein the module state data indicates that the vehicle-end operation module is faulty.

The vehicle-end operation module may be a certain component in the vehicle or a certain algorithm module operated in the vehicle.

The module state data may be data for indicating the operation state of the algorithm module. For example, the module state data can include WARNING, ERROR and/or others, which may be module states corresponding to different value ranges set based on different values of the execution rate of the algorithm module. For example, if the execution rate is lower than a certain value, the state of the algorithm module can be set to WARNING, and if the execution rate is further decreased, the WARNING state is changed to ERROR state. The module state data of WARNING or ERROR indicates that the vehicle-end operation module is faulty.

In some implementations, the cloud server can acquire the module state data of the vehicle-end operation module sent by the vehicle end, which may be a module state determined by the vehicle end according to the execution rate of the algorithm module.

Step 402: generating the data screening information based on the module state data.

In this step, the data screening information is determined in response to the fact that module state data of a vehicle-end operation module in the vehicle indicates that the vehicle-end operation module is faulty. Thus, when the algorithm module in the vehicle end of this embodiment is faulty, the determination of the data screening information can be triggered to perform the back transmission after the data screening.

The data screening information can be obtained by a screening rule-based mode or a screening model-based mode. For example, it is assumed that in the obtained data screening information, the data items to be transmitted back include: availability data of a key algorithm module and a key system peripheral device of the autonomous vehicle (which can be referred to as first data for the convenience of subsequent description), performance data of the faulty algorithm module (which can be referred to as second data), system performance data and/or availability data of the automatic driving system at the vehicle end (which can be referred to as third data). For the first data, different key algorithm modules and key system peripheral devices can be defined according to automatic driving systems of different levels. The availability data can include data such as operation delay data and frame rate data of the algorithm modules, and the performance data can include data such as memory occupancy rate and CPU occupancy rate. Different data can be obtained by different modes. For example, the performance data can be obtained in real time by system calling, file handling and/or others. The data transmitted between algorithm modules can be captured by shared memory transmission or socket transmission, and so on.

Further, the data screening information generated based on the module state data can also include priority of various data items. For example, the first data can be set with the highest priority, the second data can be set with the second highest priority, and the third data can be set with the lowest priority. The target data corresponding to the above data items are transmitted back sequentially according to the set priority.

It should be noted that the above data back transmission is only an example, different data screening information is set according to different module state data, and a screening rule can be set or a screening model can be trained independently by the research personnel, for example, the setting can be performed in a flexible way according to actual business requirements. Generally, the parameters that are more helpful to aid in positioning a fault factor of the vehicle-end operation module is determined as target data to be transmitted back.

Step 404: acquiring the target data corresponding to the faulty vehicle-end operation module in the vehicle from the vehicle-end data collected by the vehicle based on the data screening information.

Step 406: sending the target data to a data receiver.

For example, the vehicle sends the target data to a cloud server, the cloud server sends the data to the front end, and the administrator performs analysis and debugging according to the data transmitted back, finds out the cause to the faulty algorithm module, and performs the fault repair on the autonomous vehicle in time.

In the data transmission method according to this embodiment, the target vehicle-end data corresponding to the faulty vehicle-end operation module in the vehicle are timely transmitted back, so that the cause to the faulty vehicle-end can be found out more quickly, and the operation fault of the autonomous vehicle can be solved as quickly as possible.

In order to implement the data transmission method according to any one of the embodiments of the present disclosure, the embodiments of the present disclosure also provide a data transmission apparatus. The structure of the apparatus is briefly described below, where the specific processing and interaction between modules can be described with reference to the method in the example. FIG. 5 is a schematic diagram showing the structure of a data transmission apparatus according to at least one embodiment of the present disclosure. As shown in FIG. 5, the apparatus can comprise an information determination module 51, a data acquisition module 52 and a data sending module 53.

The information determination module 51 is configured for determining data screening information, wherein the data screening information includes: at least one data item to be transmitted back.

The data acquisition module 52 is configured for acquiring target data corresponding to each of the data item from vehicle-end data corresponding to the vehicle.

The data sending module 53 is configured for sending the target data to a data receiver.

In one example, the data items in the data screening information include: data attributes of the target data corresponding to the data items, wherein the data attributes include at least one of a data generation object, data generation time and a data type.

The information determination module 51 can be configured to determine the data screening information. In various example, the information determination module 51 determines the data screening information in different manners. In one example, the information determination module 51 is configured to determine the data screening information by performing operations including receive the input data screening information.

In one example, the information determination module 51 is configured to determine the data screening information by performing operations including generate the data screening information based on at least part of the vehicle-end data; wherein the at least part of the vehicle-end data includes at least one of: vehicle state data of the vehicle, environment data of the vehicle, and communication condition data of the vehicle.

In one example, the information determination module 51 is configured to determine the data screening information by performing operations comprising: acquiring at least part of the vehicle-end data corresponding to the vehicle; and determining the data screening information corresponding to the at least part of the vehicle-end data based on a preset mapping relationship between the vehicle-end data and the data screening information.

In one example, the information determination module 51 is configured to determine the data screening information by performing operations comprising: acquiring at least part of the vehicle-end data corresponding to the vehicle; and obtaining the data screening information output by a pre-trained screening model based on the at least part of the vehicle-end data input into the screening model.

In one example, the information determination module 51 is configured to determine the data screening information by performing operations comprising: obtaining first data screening information according to a first information generation mode; obtaining second data screening information according to a second information generation mode; and obtaining the final data screening information based on a joint processing of the first data screening information and the second data screening information.

In one example, the first data screening information and the second data screening information include: an importance parameter corresponding to each of at least one data item to be transmitted back. In some examples, the information determination module 51 is configured to obtain the final data screening information based on a joint processing of the first data screening information and the second data screening information. In some example, the operations performed by the information determination module 51 comprises: selecting at least part of data items in the first data screening information and the second data screening information according to the importance parameters, and setting the at least part of data items in the final data screening information.

In one example, the information determination module 51 is configured to obtain second data screening information according to a second information generation mode. In some example, the second data screening information is obtained according to the second information generation mode based on at least part of the first data screening information.

In one example, the information determination module 51 is configured to determining the data screening information by performing operations comprising obtaining multiple pieces of reference screening information, wherein each piece of the reference screening information includes at least one reference data item to be transmitted back; and determining the final data items included in the data screening information based on the reference data items included in the multiple pieces of reference screening information.

In one example, the data screening information also includes: priority corresponding to each of the at least one data item. The data sending module 53 is configured to send the target data to a data receiver. In some examples, the data sending module 53 sends the target data by performing operations comprising preferentially transmitting the target data corresponding to the data item with higher priority back according to the priority corresponding to each of the data items.

In one example, the information determination module 51 is configured to determine the data screening information. In some examples, the information determination module 51 determines the data screening information in response to the fact that module state data of a vehicle-end operation module in the vehicle indicates that the vehicle-end operation module is faulty. The data acquisition module 52 is configured to acquire target data corresponding to each of the data items from vehicle-end data collected by a vehicle. In some examples, the data acquisition module 52 acquires target data corresponding to the faulty vehicle-end operation module in the vehicle corresponding to the data items from the vehicle-end data collected by the vehicle based on the data screening information.

In one example, the information determination module 51 is configured to determine the data screening information. In some examples, the information determination module 51 determines the data screening information in response to the fact that the communication condition data for sending the target data to the data receiver is lower than the preset communication condition.

In one example, the data receiver comprises a plurality of front ends. The data sending module 53 is configured to send the target data to a data receiver. In some examples, the data sending module 53 sends the target data corresponding to the data items in the data screening information to the corresponding front ends by the cloud server based on the data screening information corresponding to each of the plurality of front ends.

The present disclosure also provides a computer-readable storage medium having a computer program stored thereon, wherein the program, when executed by a processor, implements the data transmission method according to any one of the embodiments of the present disclosure.

The present disclosure also provides an electronic device comprising a memory and a processor, wherein the memory is configured for storing computer instructions executable on the processor, and the processor is configured for implementing the data transmission method according to any one of the embodiments of the present disclosure when executing the computer instructions.

It should be understood by those skilled in the art that one or more embodiments of the present disclosure can be provided as a method, a system, or a computer program product. Accordingly, one or more embodiments of the present disclosure can take the form of a hardware-only example, a software-only example or an embodiment combining software and hardware. Furthermore, one or more embodiments of the present disclosure can take the form of a computer program product implemented on one or more computer-usable storage media (including, but not limited to, disk memory, CD-ROM, optical memory, and the like) containing computer-usable program codes.

The embodiment of the present disclosure also provides a computer-readable storage medium, on which a computer program may be stored, wherein the program, when executed by a processor, implement the steps of the data transmission method according to any one of embodiments of the present disclosure.

All embodiments of the present disclosure are described as examples only. The same and similar parts among the embodiments can be referred to each other, and each embodiment is highlighted in differences from other embodiments.

The particular embodiments of the present disclosure are described above. Other embodiments are within the scope of the appended claims. In some cases, the operations or steps recited in the claims can be executed in an order different than in the embodiments and still achieve desirable results. In addition, the processes depicted in the drawings do not necessarily require a particular order shown or a sequential order to achieve desirable results. In some embodiments, multitasking and parallel processing may also be possible or advantageous.

Embodiments of the subject matter and functional operations described herein can be implemented in: digital electronic circuitry, tangibly embodied computer software or firmware, computer hardware comprising the structures disclosed herein and their structural equivalents, or a combination of one or more thereof. Embodiments of the subject matter described herein can be implemented as one or more computer programs, i.e., one or more modules of computer program instructions, encoded on a tangible, non-transitory program carrier for execution by, or control of the operation of, data processing apparatus. Alternatively or additionally, the program instructions can be encoded on an artificially generated propagated signal (e.g., a machine-generated electrical, optical, or electromagnetic signal) that is generated to encode information for transmission to suitable receiver apparatus for execution by the data processing apparatus. The computer storage medium may be a machine-readable storage device, a machine-readable storage substrate, a random or serial access memory device, or a combination of one or more thereof.

The processes and logic flows described herein can be executed by one or more programmable computers executing one or more computer programs to perform corresponding functions by operating on input data and generating output. The processes and logic flows can also be executed by, and apparatus can be implemented as, a special purpose logic circuitry, e.g., an FPGA (field-programmable gate array) or a multi-SIC (application-specific integrated circuit).

Computers suitable for the execution of a computer program include, for example, general and/or special purpose microprocessors, or any other type of central processing unit. Generally, a central processing unit will receive instructions and data from a read-only memory and/or a random access memory. The basic components of a computer include a central processing unit for implementing or executing instructions, and one or more memory devices for storing instructions and data. Generally, a computer will also include one or more mass storage devices for storing data, e.g., magnetic disks, magneto-optical disks or optical disks, or the computer can be operatively coupled to the storage devices for receiving data therefrom or transfer data thereto, or both. However, the computer does not necessarily have such devices. In addition, a computer can be embedded in another device, e.g., a mobile telephone, a personal digital assistant (PAD), a mobile audio or video player, a game console, a global positioning system (GPS) receiver, or a portable storage device such as a universal serial bus (USB) flash drive, to name a few.

Computer-readable media suitable for storing computer program instructions and data include all forms of non-volatile memory, media and memory devices, including, e.g., semiconductor memory devices (e.g., EPROM, EEPROM, and a flash memory device), magnetic disks (e.g., an internal hard disk or a removable disk), magneto-optical disks, and CD-ROM and DVD-ROM disks. The processor and the memory can be supplemented by, or incorporated in, a special purpose logic circuitry.

Although the present disclosure contains many specific implementation details, these should not be construed as limitations on the scope of any disclosure or the claimed scope, but rather as descriptions of features of the particular embodiments of the disclosure. Certain features that are described herein in multiple embodiments can also be implemented in combination in a single embodiment. In another aspect, various features that are described in a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination may be directed to a subcombination or variation of a subcombination.

Similarly, although operations are depicted in the drawings in a particular order, this should not be understood as requiring that such operations be executed in a particular order shown or in a sequential order, or that all illustrated operations be executed, to achieve desirable results. In some cases, multitasking and parallel processing may be advantageous. Moreover, the separation of various system modules and components in the above embodiments should not be understood as requiring such separation in all embodiments, and it should be understood that the described program components and systems can generally be integrated together in a single software product or packaged into multiple software products.

Thus, the particular embodiments of the subject matter have been described.

Other embodiments are within the scope of the appended claims. In some cases, the actions recited in the claims can be executed in a different order and still achieve desirable results. In addition, the processes depicted in the drawings do not necessarily require a particular order shown or a sequential order to achieve desirable results. In some implementations, multitasking and parallel processing may be advantageous.

The above description is intended only to serve as a preferred embodiment of one or more embodiments of the present disclosure, and should not be taken as limiting the one or more embodiments of the present disclosure, and any modifications, equivalents, improvements and the like made within the spirit and principle of one or more embodiments of the present disclosure should be included in the protection scope of one or more embodiments of the present disclosure.

What is claimed is:

1. A data transmission method, comprising:
determining data screening information, wherein the data screening information comprises at least one data item to be transmitted;
acquiring target data corresponding to each of the at least one data item from vehicle-end data corresponding to a vehicle; and
sending the target data to a data receiver.

2. The method according to claim 1, wherein
the at least one data item in the data screening information comprises:
data attributes of the target data corresponding to the data items, wherein the data attributes comprise: at least one of a data generation object, data generation time, or a data type.

3. The method according to claim 1, wherein
the determining data screening information comprises:
receiving the data screening information.

4. The method according to claim 1, wherein
the determining data screening information comprises:
generating the data screening information based on at least part of the vehicle-end data;
wherein the at least part of the vehicle-end data comprises at least one of: vehicle state data of the vehicle, environment data of the vehicle, or communication condition data of the vehicle.

5. The method according to claim 1, wherein
the determining data screening information comprises:
acquiring at least part of the vehicle-end data corresponding to the vehicle; and
determining the data screening information corresponding to the at least part of the vehicle-end data based on a preset mapping relationship between the vehicle-end data and the data screening information.

6. The method according to claim 1, wherein
the determining data screening information comprises:
acquiring at least part of the vehicle-end data corresponding to the vehicle; and
obtaining the data screening information output by a pre-trained screening model based on the at least part of the vehicle-end data.

7. The method according to claim 1, wherein
the determining data screening information comprises:
obtaining first data screening information according to a first information generation mode;
obtaining second data screening information according to a second information generation mode; and
obtaining the data screening information based on a joint processing of the first data screening information and the second data screening information.

8. The method according to claim 7, wherein each piece of the first data screening information and the second data screening information comprises: an importance parameter corresponding to each of the at least one data item to be transmitted;
the obtaining the data screening information based on the joint processing of the first data screening information and the second data screening information comprises:
selecting at least part of data items in the first data screening information and the second data screening information according to the importance parameters, and setting the at least part of data items in the data screening information.

9. The method according to claim 7, wherein
the obtaining second data screening information according to the second information generation mode comprises:
obtaining the second data screening information according to the second information generation mode based on at least part of the first data screening information.

10. The method according to claim 1, wherein
the determining data screening information comprises:
obtaining multiple pieces of reference screening information, wherein each piece of the reference screening information comprises: at least one reference data item to be transmitted; and
determining the data items of the data screening information based on the reference data items included in the multiple pieces of reference screening information.

11. The method according to claim 2, wherein the data screening information further comprises: priority corresponding to each of the at least one data item;
the sending the target data to the data receiver comprises: preferentially transmitting the target data corresponding to the data item with higher priority according to the priority corresponding to each of the data items.

12. The method according to claim 1, wherein
the determining data screening information comprises: determining the data screening information in response to module state data of a vehicle-end operation module in the vehicle indicating that the vehicle-end operation module is faulty;
the acquiring target data corresponding to each of the data items from vehicle-end data collected by the vehicle comprises: acquiring the target data corresponding to the faulty vehicle-end operation module in the vehicle from the vehicle-end data based on the data screening information.

13. The method according to claim 1, wherein
the determining data screening information comprises:
determining the data screening information in response to communication condition data for sending the target data to the data receiver being lower than a preset communication condition.

14. The method according to claim 1, wherein the method is executed by a cloud server, and the data receiver comprises a plurality of front ends; and
the sending the target data to the data receiver comprises:
sending the target data corresponding to data items in the data screening information to corresponding front ends by the cloud server based on the data screening information corresponding to each of the plurality of front ends.

15. An electronic device, comprising a memory and a processor, wherein the memory is configured for storing computer instructions executable on the processor, and the processor is configured to implement a method comprising:
determining data screening information, wherein the data screening information comprises at least one data item to be transmitted;
acquiring target data corresponding to each of the at least one data item from vehicle-end data corresponding to a vehicle; and
sending the target data to a data receiver.

16. The electronic device of claim 15, wherein the each of the at least one data item in the data screening information comprise:
data attributes of the target data corresponding to the data items, wherein the data attributes comprise at least one of: a data generation object, a data generation time and a data type.

17. The electronic device of claim 15, wherein
the determining data screening information comprises:
generating the data screening information based on at least part of the vehicle-end data;
wherein the at least part of the vehicle-end data comprises at least one of: vehicle state data of the vehicle, surrounding environment data of the vehicle, or communication condition data of the vehicle.

18. The electronic device of claim 15, wherein
the determining data screening information comprises:
acquiring at least part of the vehicle-end data corresponding to the vehicle; and
determining the data screening information corresponding to the at least part of the vehicle-end data based on a preset mapping relationship between the vehicle-end data and the data screening information.

19. The electronic device of claim 15, wherein
the determining data screening information comprises:
acquiring at least part of the vehicle-end data corresponding to the vehicle; and
obtaining the data screening information output by a pre-trained screening model based on the at least part of the vehicle-end data.

20. A non-transitory computer-readable storage medium having a computer program stored thereon, wherein the program, when executed by a processor, implements a data transmission method comprising:
determining data screening information, wherein the data screening information comprises at least one data item to be transmitted;
acquiring target data corresponding to each of the at least one data item from vehicle-end data corresponding to a vehicle; and
sending the target data to a data receiver.
